(19) United States
(12) Patent Application Publication
(10) Pub. No.: US 2024/0144715 A1
(43) Pub. Date: May 2, 2024

(54) SYSTEM AND METHOD FOR IDENTITY-BASED ANALYTE DETECTION AND ANALYSIS

(71) Applicant: Know Labs, Inc., Seattle, WA (US)

(72) Inventors: Phillip BOSUA, Seattle, WA (US); Ronald ERICKSON, Seattle, WA (US); Peter CONLEY, Seattle, WA (US)

(21) Appl. No.: 18/049,838

(22) Filed: Oct. 26, 2022

(51) Int. Cl. G06V 40/10; G06F 21/32

(52) U.S. Cl. CPC G06V 40/15; G06F 21/32

(57) ABSTRACT

A sensor is controlled to non-invasively detect one or more analytes in a subject based on the biological identity or a status of the subject. The biological identity or status can be obtained either from another device or from detection by the sensor itself. The detection of the analytes based on the biological identity or the status can include generating a transmit signal, transmitting the signal into the subject, obtaining a response, and processing the response to determine the presence or amount of one or more analytes. The characteristics of the transmit signal, the processing of the response, and/or the one or more analytes being detected can be selected based on the identity and/or the status of the subject.

### FIELD

This disclosure is directed to systems and methods for detecting one or more analytes in a subject based on one or both of the biological identity of the subject and/or a status of the subject.

### BACKGROUND

Access to devices, functionalities thereof, locations, and the like can be controlled based on a biological identity of a user, for example through identification materials such as passes, ID cards, and the like, knowledge-based identification such as passwords, or biometrics such as fingerprints, facial recognition, features of the eye and other such factors. The biometric factors are typically permanent, immutable characteristics of the individual to provide identification but do not reflect a current state of the identified individual. Analyte detection devices typically are configured to detect a specific set of one or more analytes, regardless of the identity of the particular subject or their particular status.

### SUMMARY

This disclosure is directed to systems and methods for detecting one or more analytes in a subject based on one or both of the biological identity of the subject and/or a status of the subject.

By controlling the non-invasive detection of analytes in a subject based on the biological identity of the subject and/or a status of the subject, detection operations by a sensor can be controlled to provide detection only for an authorized subject, or to tailor the detection or related activities such as provision of notifications to the subject based on the biological identity or status of the subject. This can allow specific calibration, detection of analytes of particular interest to a user, controlling access to particular sensing functionalities, and the like.

In an embodiment, an analyte detection system includes a sensor and a controller. The sensor includes an antenna array having at least one transmit antenna and at least one receive antenna, the at least one transmit antenna is positioned and arranged to transmit a transmit signal into a subject, and the at least one receive antenna is positioned and arranged to detect a response resulting from transmission of the transmit signal by the at least one transmit antenna into the subject. The sensor further includes a transmit circuit that is electrically connectable to the at least one transmit antenna, the transmit circuit is configured to generate a transmit signal to be transmitted by the at least one transmit antenna, the transmit signal is in a radio or microwave frequency range of the electromagnetic spectrum. The sensor also includes a receive circuit that is electrically connectable to the at least one receive antenna, the receive circuit is configured to receive a response detected by the at least one receive antenna. The controller is configured to obtain a biological identity and/or status of the subject and control a detection of one or more analytes by the sensor based on the biological identity and/or status of the subject.

In an embodiment, the controller is configured to obtain the biological identity and/or status of the subject based on processing of the response detected by the at least one receive antenna. In an embodiment, the controller is configured to obtain the biological identity and/or status of the subject by receiving an authorization permission. In an embodiment, the control of the detection includes initiating, based on the biological identity and/or status of the subject, the detection of the one or more analytes. In an embodiment, the control of the detection includes selection of the one or more analytes being detected. In an embodiment, the control of the detection includes selection of one or more frequencies to be included in the transmit signal. In an embodiment, the control of the detection includes processing of the response based on the biological identity and/or status of the subject. In an embodiment, the controller is configured to obtain the biological identity of the subject and the control of the detection is based on the biological identity of the subject. In an embodiment, the controller is configured to obtain the status of the subject and the control of the detection is based on the status of the subject.

In an embodiment, a method of detecting one or more analytes includes obtaining a biological identity and/or a status of a subject and controlling a sensor based on the biological identity and/or the status of the subject to non-invasively detect one or more analytes in the subject. Non-invasively detecting the one or more analytes includes generating a transmit signal using a transmit circuit of a sensor, transmitting the transmit signal into a subject using a transmit antenna of the sensor, the transmit signal in a radio or microwave frequency range of the electromagnetic spectrum, detecting a response resulting from transmitting the transmit signal into the subject using a receive antenna of the sensor, and processing the response to determine a presence or amount of the one or more analytes in the subject.

In an embodiment, the biological identity and/or the status is obtained by receiving an authorization permission. In an embodiment, the biological identity and/or the status is obtained by detecting one or more identity or status analytes using the sensor, and determining the biological identity and/or the status based on the one or more identity or status analytes. In an embodiment, controlling the sensor includes initiating the non-invasive detection of the one or more analytes in the subject based on the biological identity and/or the status of the subject. In an embodiment, the one or more analytes are based on the biological identity and/or the status of the subject. In an embodiment, one or more frequencies included in the transmit signal are selected based on the biological identity and/or the status of the subject. In an embodiment, the processing of the response to determine the presence or the amount of the one or more analytes is based on the biological identity and/or status of the subject. In an embodiment, the method further includes providing a notification based on the presence or amount of the one or more analytes and the biological identity and/or the status of the subject. In an embodiment, the sensor is controlled based on the biological identity of the subject. In an embodiment, the sensor is controlled based on the status of the subject.

### DRAWINGS

FIG. 1 shows a sensor according to an embodiment.

FIG. 2 shows a flowchart of a method for analyte detection according to an embodiment.

FIG. 3 shows a flowchart of a method for analyte detection according to an embodiment.

FIG. 4 shows an antenna array of a sensor according to an embodiment.

### DETAILED DESCRIPTION

This disclosure is directed to systems and methods for detecting one or more analytes in a subject based on one or both of the biological identity of the subject and/or a status of the subject.

The transmit antenna and the receive antenna are decoupled (which may also be referred to as detuned or the like) from one another. Decoupling refers to intentionally fabricating the configuration and/or arrangement of the transmit antenna and the receive antenna to minimize direct communication between the transmit antenna and the receive antenna, preferably absent shielding. Shielding between the transmit antenna and the receive antenna can be utilized. However, the transmit antenna and the receive antenna are decoupled even without the presence of shielding.

The signal(s) detected by the receive antenna can be analyzed to detect the analyte based on the intensity of the received signal(s) and reductions in intensity at one or more frequencies where the analyte absorbs the transmitted signal. Examples of detecting an analyte using a non-invasive spectroscopy sensor operating in the radio or microwave frequency range of the electromagnetic spectrum are described in WO 2019/217461, U.S. Pat. Nos. 11,063,373, 11,058,331, 11,033,208, 11,284,819, 11,284,820, 10,548,503, 11,234,619, 11,031,970, 11,223,383, 11,058,317, 11,193,923, and 11,234,618, the entire contents of which are incorporated herein by reference.

In one embodiment, the sensor described herein can be used to detect the presence of at least one analyte in a target. In another embodiment, the sensor described herein can detect an amount or a concentration of the at least one analyte in the target. The target can be any target containing at least one analyte of interest that one may wish to detect. The target can be human or non-human, animal or non-animal, biological or non-biological. For example, the target can include, but is not limited to, human tissue, animal tissue, plant tissue, an inanimate object, soil, a fluid, genetic material, or a microbe. Non-limiting examples of targets include, but are not limited to, a fluid, for example blood, interstitial fluid, cerebral spinal fluid, lymph fluid or urine, human tissue, animal tissue, plant tissue, an inanimate object, soil, genetic material, one or more microbes, combinations thereof, and the like.

The analyte(s) can be any analyte that one may wish to detect. The analyte can be human or non-human, animal or non-animal, biological or non-biological. For example, the analyte(s) can include, but is not limited to, one or more of glucose, alcohol, white blood cells, or luteinizing hormone. The analyte(s) can include, but is not limited to, a chemical, a combination of chemicals, a virus, bacteria, or the like. The analyte can be a chemical included in another medium, with non-limiting examples of such media including a fluid containing the at least one analyte, for example blood, interstitial fluid, cerebral spinal fluid, lymph fluid or urine, human tissue, animal tissue, plant tissue, an inanimate object, soil, genetic material, one or more microbes, or combinations thereof. The analyte(s) may also be a non-human, non-biological particle such as a mineral or a contaminant.

The analyte(s) can include, for example, naturally occurring substances, artificial substances, metabolites, and/or reaction products. As non-limiting examples, the at least one analyte can include, but is not limited to, insulin, acarboxyprothrombin; acylcarnitine; adenine phosphoribosyl transferase; adenosine deaminase; albumin; ketones, alpha-fetoprotein; amino acid profiles (arginine (Krebs cycle), histidine/urocanic acid, homocysteine, phenylalanine/tyrosine, tryptophan); andrenostenedione; antipyrine; arabinitol enantiomers; arginase; benzoylecgonine (cocaine); biotinidase; biopterin; c-reactive protein; carnitine; pro-BNP; BNP; troponin; carnosinase; CD4; ceruloplasmin; chenodeoxycholic acid; chloroquine; cholesterol; cholinesterase; conjugated 1-β hydroxy-cholic acid; cortisol; creatine kinase; creatine kinase MM isoenzyme; cyclosporin A; d-penicillamine; de-ethylchloroquine; dehydroepiandrosterone sulfate; DNA (acetylator polymorphism, alcohol dehydrogenase, alpha 1-antitrypsin, cystic fibrosis, Duchenne/Becker muscular dystrophy, analyte-6-phosphate dehydrogenase, hemoglobin and variants thereof including hemoglobin A, hemoglobin S, hemoglobin C, hemoglobin D, hemoglobin E, hemoglobin F, D-Punjab, and beta-thalassemia, particular conformations or conjugations of hemoglobin such as oxyhemoglobin, deoxyhemoglobin, carboxyhemoglobin, and the like, hepatitis B virus, HCMV, HIV-1, HTLV-1, Leber hereditary optic neuropathy, MCAD, RNA, PKU, Plasmodium vivax, sexual differentiation, 21-deoxycortisol); desbutylhalofantrine; dihydropteridine reductase; diptheria/tetanus antitoxin; erythrocyte arginase; erythrocyte protoporphyrin; esterase D; fatty acids/acylglycines; free β-human chorionic gonadotropin; free erythrocyte porphyrin; free thyroxine (FT4); free tri-iodothyronine (FT3); fumarylacetoacetase; galactose/gal-1-phosphate; galactose-1-phosphate uridyltransferase; gentamicin; analyte-6-phosphate dehydrogenase; glutathione; glutathione perioxidase; glycocholic acid; glycosylated hemoglobin; halofantrine; hemoglobin variants; hexosaminidase A; human erythrocyte carbonic anhydrase I; 17-alpha-hydroxyprogesterone; hypoxanthine phosphoribosyl transferase; immunoreactive trypsin; lactate; lead; lipoproteins ((a), B/A-1, β); lysozyme; mefloquine; netilmicin; phenobarbitone; phenytoin; phytanic/pristanic acid; progesterone; prolactin; prolidase; purine nucleoside phosphorylase; quinine; reverse tri-iodothyronine (rT3); selenium; serum pancreatic lipase; sissomicin; somatomedin C; specific antibodies (adenovirus, anti-nuclear antibody, anti-zeta antibody, arbovirus, Aujeszky's disease virus, dengue virus, Dracunculus medinensis, Echinococcus granulosus, Entamoeba histolytica, enterovirus, Giardia duodenalisa, Helicobacter pylori, hepatitis B virus, herpes virus, HIV-1, IgE (atopic disease), influenza virus, Leishmania donovani, leptospira, measles/mumps/rubella, Mycobacterium leprae, Mycoplasma pneumoniae, Myoglobin, Onchocerca volvulus, parainfluenza virus, Plasmodium falciparum, polio virus, Pseudomonas aeruginosa, respiratory syncytial virus, rickettsia (scrub typhus), Schistosoma mansoni, Toxoplasma gondii, Trepenoma pallidium, Trypanosoma cruzi/rangeli, vesicular stomatis virus, Wuchereria bancrofti, yellow fever virus); specific antigens (hepatitis B virus, HIV-1); succinylacetone; sulfadoxine; theophylline; thyrotropin (TSH); thyroxine (T4); thyroxine-binding globulin; trace elements; transferrin; UDP-galactose-4-epimerase; urea; uroporphyrinogen I synthase; vitamin A; white blood cells; and zinc protoporphyrin.

In embodiments, the analytes can include one or more indicators for determination of hydration of a subject. The analytes can include, for example, hemoglobin, red blood cells as a whole, one or more hormones, sodium, one or more solutes from which osmolarity can be determined, or the like. The amount of the analytes can be used to determine one or more indicia of hydration, such as concentrations of one or more analytes, hematocrit, osmolarity, or any other suitable measurement of a hydration level of the subject. The osmolarity can be an osmolarity of one or more of plasma, interstitial fluid, saliva, urine, or the like. In an embodiment, a sensor can be positioned such that the results of detection are indicative of the presence or amount of analytes in the bladder of the subject, such that urine parameters related to hydration such as urine osmolarity can be determined. In an embodiment, the sensor can be positioned such that results of detection are indicative of the presence or amount of analytes in saliva. A hydration level can be determined based on the one or more indicators, for example by comparing osmolarity or hematocrit to reference values. The reference values can be reference values specific to the subject, general reference values, reference values for a group that the subject belongs to, or the like. In an embodiment, the sensor can detect the one or more analytes in the subject non-invasively. In an embodiment, the sensor can detect the one or more analytes in a sample obtained from the subject, such as a blood, urine, or saliva sample. The sample can have a predetermined mass or volume.

The analyte(s) can also include one or more chemicals introduced into the target. The analyte(s) can include a marker such as a contrast agent, a radioisotope, or other chemical agent. The analyte(s) can include a fluorocarbon-based synthetic blood. The analyte(s) can include a drug or pharmaceutical composition or metabolites thereof, with non-limiting examples including ethanol or other alcohols; ketones; cannabis (marijuana, tetrahydrocannabinol, hashish); inhalants (nitrous oxide, amyl nitrite, butyl nitrite, chlorohydrocarbons, hydrocarbons); cocaine (crack cocaine); stimulants (amphetamines, methamphetamines, Ritalin, Cylert, Preludin, Didrex, PreState, Voranil, Sandrex, Plegine); depressants (barbiturates, methaqualone, tranquilizers such as Valium, Librium, Miltown, Serax, Equanil, Tranxene); hallucinogens (phencyclidine, lysergic acid, mescaline, peyote, psilocybin); narcotics (heroin, codeine, morphine, opium, meperidine, Percocet, Percodan, Tussionex, Fentanyl, Darvon, Talwin, Lomotil); designer drugs (analogs of fentanyl, meperidine, amphetamines, methamphetamines, and phencyclidine, for example, Ecstasy); anabolic steroids; and nicotine. The analyte(s) can include other drugs or pharmaceutical compositions. The analyte(s) can include neurochemicals or other chemicals generated within the body, such as, for example, ascorbic acid, uric acid, dopamine, noradrenaline, 3-methoxytyramine (3MT), 3,4-Dihydroxyphenylacetic acid (DOPAC), Homovanillic acid (HVA), 5-Hydroxytryptamine (5HT), and 5-Hydroxyindoleacetic acid (FHIAA).

In an embodiment, the one or more analyte(s) can be detected in some or all of a plurality of tissues, bodily fluids, and the like that are subjected to a transmit signal, in turn resulting in a response signal. For example, a transmit signal into a subject at a location where the transmit signal passes through, for example, skin, bone, muscle, interstitial fluid, blood vessels, and blood can result in a response signal indicative of the presence or amount of analytes present in some or all of the tissues and/or fluids that the transmit signal enters into or passes through. In embodiments, the response signal can be indicative of the presence or amount of some or all of a plurality of organs, such as the liver, the pancreas, the kidneys, the gallbladder, and/or any other such organ. In an embodiment, the response signal can be parsed based on characteristics thereof to estimate or determine the presence or amount of the analyte(s) in particular tissues and/or bodily fluids, for example the presence or amount of the analyte specifically present in blood, interstitial fluid, a particular tissue or organ, or the like.

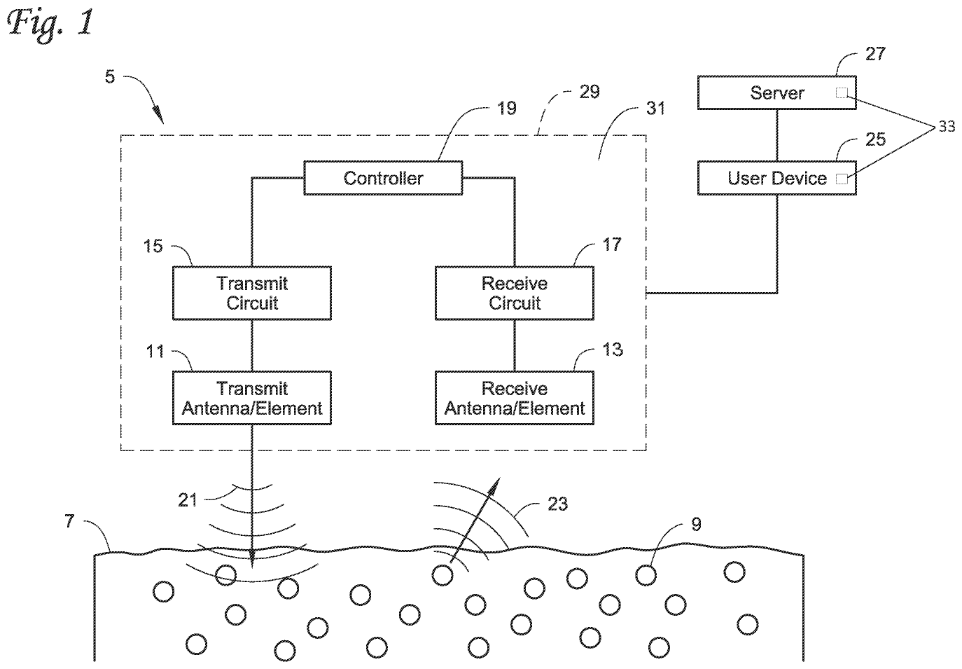

FIG. 1 shows a sensor at a measurement location according to an embodiment. An embodiment of a non-invasive analyte sensor system with a non-invasive analyte sensor 5 is illustrated. The sensor 5 is depicted relative to a target 7 that contains one or more analyte(s) of interest 9. In this example, the sensor 5 is depicted as including an antenna array that includes a transmit antenna/element 11 (hereinafter “transmit antenna 11”) and a receive antenna/element 13 (hereinafter “receive antenna 13”). The sensor 5 further includes a transmit circuit 15, a receive circuit 17, and a controller 19. As discussed further below, the sensor 5 can also include a power supply, such as a battery (not shown in FIG. 1). Sensor 5 can be a non-invasive sensor. Non-invasive sensing can include sensing without disruption to tissue of a subject, for example without requiring injection, implantation into the subject, or the like. It is understood that while sensor 5 is a non-invasive sensor capable of non-invasive sensing, it can also be used to detect the one or more analytes in samples that have been obtained from a subject such as blood or tissue samples.

The analyte(s) of interest 9 are to be detected at target 7. The target can be one or more parts of a subject using the sensor 5. For example, the target 7 can be any one or more of, for example, the lower left leg, upper left leg, lower right leg, upper right leg, lower left arm, upper left arm, groin, abdomen, chest, neck, and/or the head of the subject using sensor 5.

The transmit antenna 11 is positioned, arranged and configured to transmit a signal 21 that is the radio frequency (RF) or microwave range of the electromagnetic spectrum into the target 7. The transmit antenna 11 can be an electrode or any other suitable transmitter of electromagnetic signals in the radio frequency (RF) or microwave range. The transmit antenna 11 can have any arrangement and orientation relative to the target 7 that is sufficient to allow the analyte sensing to take place. In one non-limiting embodiment, the transmit antenna 11 can be arranged to face in a direction that is substantially toward the target 7.

The signal 21 transmitted by the transmit antenna 11 is generated by the transmit circuit 15 which is electrically connectable to the transmit antenna 11. The transmit circuit 15 can have any configuration that is suitable to generate a transmit signal to be transmitted by the transmit antenna 11. Transmit circuits for generating transmit signals in the RF or microwave frequency range are well known in the art. In one embodiment, the transmit circuit 15 can include, for example, a connection to a power source, a frequency generator, and optionally filters, amplifiers or any other suitable elements for a circuit generating an RF or microwave frequency electromagnetic signal. In an embodiment, the signal generated by the transmit circuit 15 includes a frequency in the range from about 10 kHz to about 100 GHz. In another embodiment, the frequency can be in a range from about 300 MHz to about 6000 MHz. In an embodiment, the transmit circuit 15 can be configured to sweep through a range of frequencies that are within the range of about 10 kHz to about 100 GHz, or in another embodiment a range of about 300 MHz to about 6000 MHz.

The receive antenna 13 is positioned, arranged, and configured to detect one or more electromagnetic response signals 23 that result from the transmission of the transmit signal 21 by the transmit antenna 11 into the target 7 and impinging on the analyte(s) 9. The receive antenna 13 can be an electrode or any other suitable receiver of electromagnetic signals in the radio frequency (RF) or microwave range. In an embodiment, the receive antenna 13 is configured to detect electromagnetic signals including a frequency in the range from about 10 kHz to about 100 GHz, or in another embodiment a range from about 300 MHz to about 6000 MHz. The receive antenna 13 can have any arrangement and orientation relative to the target 7 that is sufficient to allow detection of the response signal(s) 23 to allow the analyte sensing to take place. In one non-limiting embodiment, the receive antenna 13 can be arranged to face in a direction that is substantially toward the target 7. When the target 7 is a living subject or a part thereof, the signal obtained by receive antenna 13 can be indicative of the analyte(s) present in at least both the blood and the interstitial fluid of the living subject.

The receive circuit 17 is electrically connectable to the receive antenna 13 and conveys the received response from the receive antenna 13 to the controller 19. The receive circuit 17 can have any configuration that is suitable for interfacing with the receive antenna 13 to convert the electromagnetic energy detected by the receive antenna 13 into one or more signals reflective of the response signal(s) 23. The construction of receive circuits are well known in the art. The receive circuit 17 can be configured to condition the signal(s) prior to providing the signal(s) to the controller 19, for example through amplifying the signal(s), filtering the signal(s), or the like. Accordingly, the receive circuit 17 may include filters, amplifiers, or any other suitable components for conditioning the signal(s) provided to the controller 19.

The controller 19 controls the operation of the sensor 5. The controller 19, for example, can direct the transmit circuit 15 to generate a transmit signal to be transmitted by the transmit antenna 11. The controller 19 further receives signals from the receive circuit 17. The controller 19 can optionally process the signals from the receive circuit 17 to detect the analyte(s) 9 in the target 7. Control of the operation of sensor 5 by controller 19 can be based on a biological identity and/or a status of the subject including target 7. The biological identity can be obtained by the controller by receiving data from another device such as external device 25 and/or remote server 27, from processing a response received from response circuit 17, or any other suitable source of biological identity and/or status data. Biological identity can be a specific identity of an individual, confirmation that the individual is part of a particular group, or the like. Status can be a current state of the individual such as an intoxication status based on the presence or amount of one or more intoxicants such as alcohol, prescription or recreational drugs, or the like. Other example statuses can include tiredness or exhaustion, attentiveness, sickness, and the like. In an embodiment, statuses can be based on the presence or amounts of least some of the one or more analytes detected using the sensor 5, such as biomarkers associated with the statuses, drugs or associated compounds having the statuses as a side effect or resulting condition, particular pathogens or indicators thereof, and the like.

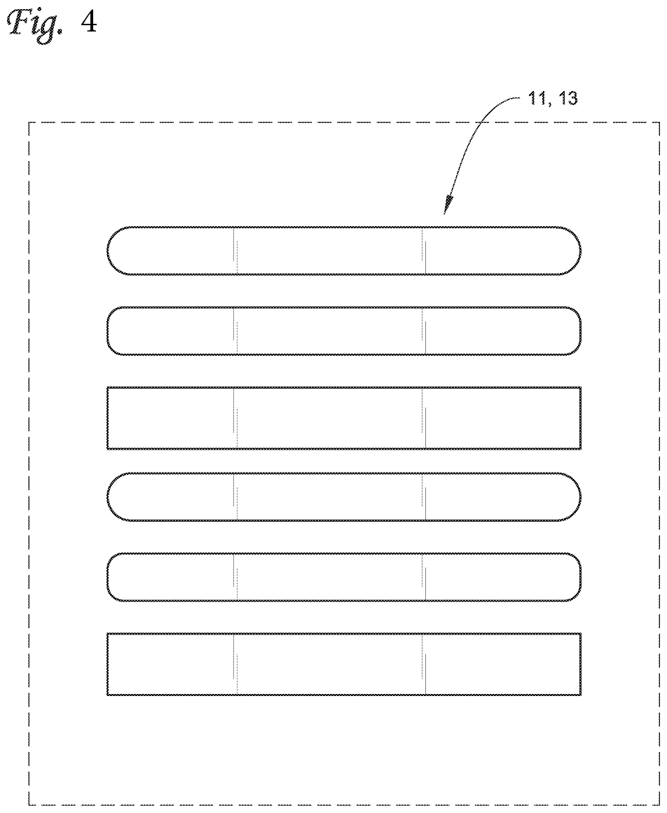

The control of the operation of sensor 5 by controller 19 can include initiation of a detection operation for one or more analytes in response to receiving a particular biological identity and/or status of the subject. A detection operation can be use of the sensor to detect one or more analytes by generating a transmit signal, transmitting the transmit signal into the subject, obtaining a response from the subject, and processing the response to determine a presence or amount of the one or more analytes. The control of operation of sensor 5 by controller 19 can include selecting one or more frequencies to include in the transmit signal generated by the transmit circuit 15 based on the biological identity and/or status of the subject. In an embodiment, the control of the operation of sensor 5 by controller 19 can include selection of the one or more analytes to be detected by operation of the sensor 5 based on the biological identity and/or status of the subject. The selection of the one or more analytes to be detected can in turn control one or both of the generation of the transmit signal by transmit circuit 15 and/or the processing of the response signal by the controller 19 to determine levels of the one or more analytes. In an embodiment, the control of the operation of sensor 5 by controller 19 can include selection of one or more antennas of an antenna array, such as the antenna array shown in FIG. 4 and described below, to be used as the transmit antenna 11 or the receive antenna 13. In an embodiment, the control of the operation of sensor 5 by controller 19 can include control of the processing of the signals from the receive circuit 17, to detect particular analytes based on the biological identity and/or status of the subject. In an embodiment, the control of the operation of sensor 5 by controller 19 can include control of the processing of signal received from receive circuit 17 to adjust the processing when determining the presence or amount of the one or more analytes to provide calibration or other individualized adjustment to the determination of the presence or amount of the one or more analytes based on the biological identity and/or status of the subject. In an embodiment, the controller 19 can be configured to determine the biological identity and/or status of the subject based on the signal received from receive circuit 17. In this embodiment, the controller 19 can initiate another detection cycle based on the determined biological identity and/or status of the subject and/or further process the signal received from receive circuit 17 based on the determine d identity and/or status of the subject.

In one embodiment, the controller 19 may optionally be in communication with at least one external device 25 such as a user device and/or a remote server 27, for example through one or more wireless connections such as Bluetooth, wireless data connections such a 4G, 5G, LTE or the like, or Wi-Fi. If provided, the external device 25 and/or remote server 27 may process (or further process) the signals that the controller 19 receives from the receive circuit 17, for example to detect the analyte(s) 9. In an embodiment, processing or further processing of signals that controller 19 receives from receive circuit 17 can be performed based on the biological identity and/or status of the subject. If provided, the external device 25 may be used to provide communication between the sensor 5 and the remote server 27, for example using a wired data connection or via a wireless data connection or Wi-Fi of the external device 25 to provide the connection to the remote server 27. In an embodiment, the external device 25 and/or remote serve 27 can provide the biological identity and/or status of the subject to the controller 19. In an embodiment, the external device 25 and/or remote server 27 can determine the biological identity and/or status through any suitable measurement, such as fingerprints, eye imaging, facial recognition, detection of one or more analytes, breath alcohol measurements, or the like. In an embodiment, the external device 25 and/or remote server 27 can process a signal provided by the controller 19, such as the signal from receive circuit 17 or a partially processed signal based on the signal from receive circuit 17 in order to determine the biological identity and/or status of the subject. The external device 25 and/or remote server 27 can provide an authorization permission to the controller 19 based on determination of the biological identity and/or status of the subject. The authorization permission can include the biological identity and/or status of the subject directly, or controls for the controller 19 to execute based on the biological identity and/or status of the subject. In an embodiment, the external device 25 is a mobile device of the subject.

In an embodiment, controller 19 can be configured to determine a presence or amount of the one or more analytes at the target based on the return signal. In an embodiment, the external device 25 or remote server 27 can include a controller 33 configured to determine the presence or amount of the one or more analytes at the target based on the return signal. The determination of the presence or amount of the one or more analytes can be based in part on the biological identity and/or status of the subject. For example, the selection of the one or more analytes to be detected by the processing of the response can be based on the biological identity and/or status of the subject. In an embodiment, the processing can be modified according to the biological identity and/or status of the subject, for example to apply specific calibration or other adjustments based on the identity and/or status of the subject. In an embodiment, the controller 19 and/or the controller 33 can provide a notification based on notification criteria applied based on the biological identity and/or status of the subject, the notification criteria including levels of one or more of the detected one or more analytes.

In an embodiment, at least one of controllers 19 or 33 is configured to determine a biological identity and/or a status of the subject based on the presence or amount of the one or more analytes. The determination of identity and/or status can be based on a comparison of the presence or amount of the one or more analytes to values for the one or more analytes that are associate with or indicative of the biological identity and/or the status of the individual. Based on the particular identity and/or status, at least one of the controllers 19 and/or 33 can be used to control a subsequent detection action for the individual including target 7. The control of the subsequent detection action can be based at least in part on the biological identity of the individual, such as being an owner of the sensor 5, a subscriber or authorized one-time user to one or more sensing services using the sensor 5, and the like. The control of the subsequent detection action can be based at least in part on the status of the individual, being based on intoxication by alcohol and/or other drugs, in a state of sufficient alertness, presence or absence of communicable diseases, or the like. In embodiments, both the biological identity and the status can be used to determine the control of the subsequent detection action, such as only operating the sensor 5 for specific persons, and operating the sensor 5 conditionally based on the status. In embodiments, additional external factors can be included in the determination of the control of the subsequent detection action, such as date, time, triggers such as events, and the like. For example, operation of the sensor can be restricted based on certain dates and/or ranges of hours in addition to the biological identity and/or the status of the subject.

With continued reference to FIG. 1, the sensor 5 may include a sensor housing 29 (shown in dashed lines) that defines an interior space 31. Components of the sensor 5 may be attached to and/or disposed within the housing 29. For example, the transmit antenna 11 and the receive antenna 13 are attached to the housing 29. In some embodiments, the antennas 11, 13 may be entirely or partially within the interior space 31 of the housing 29. In some embodiments, the antennas 11, 13 may be attached to the housing 29 but at least partially or fully located outside the interior space 31. In some embodiments, the transmit circuit 15, the receive circuit 17 and the controller 19 are attached to the housing 29 and disposed entirely within the sensor housing 29. In an embodiment, the sensor housing 29 is included in a wearable device. In an embodiment, the sensor housing 29 is included in a mobile computing device such as a smartphone, a tablet computer, or a laptop computer. In an embodiment, the sensor housing is included in a sensing station or in a sensing device such as a blood pressure cuff.

The receive antenna 13 is decoupled or detuned with respect to the transmit antenna 11 such that electromagnetic coupling between the transmit antenna 11 and the receive antenna 13 is reduced. The decoupling of the transmit antenna 11 and the receive antenna 13 increases the portion of the signal(s) detected by the receive antenna 13 that is the response signal(s) 23 from the target 7, and minimizes direct receipt of the transmitted signal 21 by the receive antenna 13. The decoupling of the transmit antenna 11 and the receive antenna 13 results in transmission from the transmit antenna 11 to the receive antenna 13 having a reduced forward gain (S21) and an increased reflection at output (S22) compared to antenna systems having coupled transmit and receive antennas.

In an embodiment, coupling between the transmit antenna 11 and the receive antenna 13 is 95% or less. In another embodiment, coupling between the transmit antenna 11 and the receive antenna 13 is 90% or less. In another embodiment, coupling between the transmit antenna 11 and the receive antenna 13 is 85% or less. In another embodiment, coupling between the transmit antenna 11 and the receive antenna 13 is 75% or less.

Any technique for reducing coupling between the transmit antenna 11 and the receive antenna 13 can be used. For example, the decoupling between the transmit antenna 11 and the receive antenna 13 can be achieved by one or more intentionally fabricated configurations and/or arrangements between the transmit antenna 11 and the receive antenna 13 that is sufficient to decouple the transmit antenna 11 and the receive antenna 13 from one another.

For example, in one embodiment described further below, the decoupling of the transmit antenna 11 and the receive antenna 13 can be achieved by intentionally configuring the transmit antenna 11 and the receive antenna 13 to have different geometries from one another. Intentionally different geometries refers to different geometric configurations of the transmit and receive antennas 11, 13 that are intentional. Intentional differences in geometry are distinct from differences in geometry of transmit and receive antennas that may occur by accident or unintentionally, for example due to manufacturing errors or tolerances.

Another technique to achieve decoupling of the transmit antenna 11 and the receive antenna 13 is to provide appropriate spacing between each antenna 11, 13 that is sufficient to decouple the antennas 11, 13 and force a proportion of the electromagnetic lines of force of the transmitted signal 21 into the target 7 thereby minimizing or eliminating as much as possible direct receipt of electromagnetic energy by the receive antenna 13 directly from the transmit antenna 11 without traveling into the target 7. The appropriate spacing between each antenna 11, 13 can be determined based upon factors that include, but are not limited to, the output power of the signal from the transmit antenna 11, the size of the antennas 11, 13, the frequency or frequencies of the transmitted signal, and the presence of any shielding between the antennas. This technique helps to ensure that the response detected by the receive antenna 13 is measuring the analyte(s) 9 and is not just the transmitted signal 21 flowing directly from the transmit antenna 11 to the receive antenna 13. In some embodiments, the appropriate spacing between the antennas 11, 13 can be used together with the intentional difference in geometries of the antennas 11, 13 to achieve decoupling.

In one embodiment, the transmit signal (or each of the transmit signals) can be transmitted over a transmit time that is less than, equal to, or greater than about 300 ms. In another embodiment, the transmit time can be than, equal to, or greater than about 200 ms. In still another embodiment, the transmit time can be less than, equal to, or greater than about 30 ms. The transmit time could also have a magnitude that is measured in seconds, for example 1 second, 5 seconds, 10 seconds, or more. In an embodiment, the same transmit signal can be transmitted multiple times, and then the transmit time can be averaged. In another embodiment, the transmit signal (or each of the transmit signals) can be transmitted with a duty cycle that is less than or equal to about 50%.

Further information on the sensor 5 and its components and variations thereof can be found in U.S. Pat. Nos. 11,063,373, 11,234,619, 11,031,970, 11,223,383, 11,058,317, 11,058,331, 11,193,923, 10,548,503, 11,330,997, 11,033,208, 11,234,618, 11,284,819, and 11,284,820, the entire contents of which are incorporated herein by reference in their entirety.

In an embodiment, the sensor 5 can be incorporated into a wearable device such as a ring, a watch, or any other suitable wearable device. For example, housing 29 can be provided on or in the wearable device. The wearable device including sensor 5 can be capable of detecting physiological parameters such as heart rate, blood pressure, oxygen level, hydration level, body temperature, calorie consumption, glucose level, one or more hormone levels, or the like. One or more of the physiological parameters can be detected using sensor 5 or determined based on detection of one or more analytes by the sensor 5. In an embodiment, one or more of the physiological parameters can be detected or determined using another sensor included in the wearable device in addition to the sensor 5. This other sensor can be any suitable sensor for the particular physiological parameter. In an embodiment, one or more of the physiological parameters can be determined based on a presence or amount of one or more analytes detected by the sensor 5 and one or more additional measurements made by another sensor included in the wearable device.

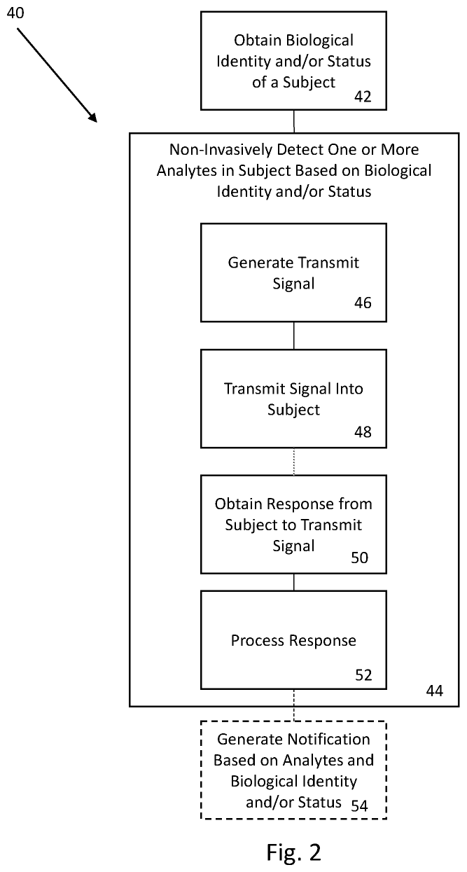

FIG. 2 shows a flowchart of a method for analyte detection according to an embodiment. Method 40 includes obtaining a biological identity and/or a status of a subject 42. The method 40 includes non-invasively detecting one or more analytes in the subject 44, based on the obtained identity and/or status. Non-invasively detecting the one or more analytes in the subject at 44 can include generating a transmit signal 46, transmitting the transmit signal into the subject 48, and obtaining a response signal 50. The response signal can be processed at 52 to determine a presence or amount of the one or more analytes. Optionally, a notification can be generated 54 based on the presence or amount of the one or more analytes and the biological identity and/or the status of the subject.

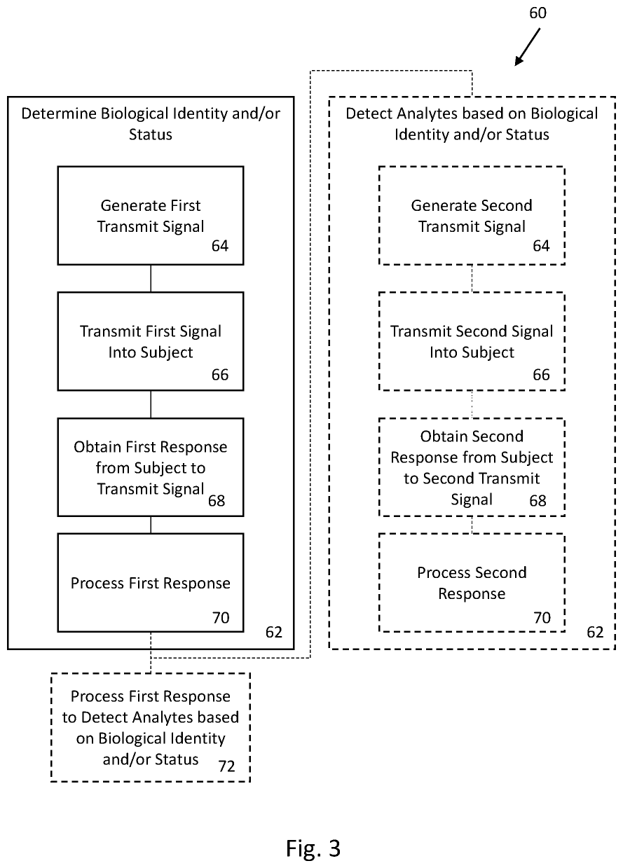

A biological identity and/or status of the subject is obtained at 42. Biological identity can be a specific identity of an individual, confirmation that the individual is part of a particular group, or the like. Status can be a current state of the individual such as an intoxication status based on the presence or amount of one or more intoxicants such as alcohol, prescription or recreational drugs, or the like. Other example statuses can include tiredness or exhaustion, attentiveness, sickness, and the like. The biological identity and/or status of the subject can be obtained 42 from another device separate the sensor, such as external device 25 and/or remote server 27 as described above and shown in FIG. 1. In an embodiment, the device separate from the sensor provides an authorization permission to the sensor used for non-invasively detecting the one or more analytes at 44, with the authorization permission being based on the biological identity and/or status of the subject. In an embodiment, the authorization permission includes at least one of the biological identity of the subject, the status of the subject, or one or more commands regarding performance of the detection or the one or more analytes at 44 or steps thereof. In an embodiment, the biological identity and/or status of the subject can be obtained 42 from a biometric reader such as, for example a fingerprint scanner, facial recognition, eye imaging, or the like. The biometric reader can be an external device, a component of an external device, a component of a device including the sensor controlled according to method 40, or the like. In an embodiment, the biological identity and/or status can be obtained 42 by way of a detection operation of the sensor used to perform the non-invasive detection of the one or more analytes at 44, for example as shown in FIG. 3 and discussed below.

Non-invasive detection of one or more analytes is performed at 44, based on the biological identity and/or status of the subject. The non-invasive detection at 44 can be performed using a sensor such as the sensor 5 described above and shown in FIG. 1. In an embodiment, the performance of the non-invasive detection of the one or more analytes at 44 can be permitted or blocked based on the biological identity and/or the status of the subject. In an embodiment, the performance of the non-invasive detection of the one or more analytes at 44 can be triggered based on the biological identity and/or the status being obtained at 42. In an embodiment, the one or more analytes to be detected at 44 are selected based on the biological identity and/or status of the subject obtained at 42. For example, the one or more analytes detected at 44 can be according to one or more subscriptions to detection services by the subject. In another example, the one or more analytes can be selected based on relevance to the particular subject, such as glucose levels being relevant to a diabetic, or the like. In yet another example, the one or more analytes can be selected based on relevance to a status of the subject, such as detecting one or more drugs that can have adverse interactions with another drug known to be present in the subject based on the status of the subject. In an embodiment, one or more aspects of performing the detection of the one or more analytes at 44 can be controlled according to the biological identity and/or status of the subject.

Detection of the one or more analytes at 44 can include generating a transmit signal 46. The transmit signal can be generated at 46 by a transmit circuit of a sensor, such as transmit circuit 15 of sensor 5 as described above and shown in FIG. 1. In an embodiment, characteristics of the transmit signal generated at 46 can be based on the biological identity and/or status of the subject obtained at 42. For example, one or more frequencies included in the transmit signal generated at 46 can be selected based on the biological identity and/or status of the subject, for example to use frequencies known to be particularly effective for detection of the one or more analytes in a particular subject or to use frequencies known to produce responses most indicative of selected analytes being detected. In an embodiment, a range of frequencies for a frequency sweep can be based on the biological identity and/or status of the subject, for example adjusting one or more of a lower boundary frequency for the frequency sweep, an upper boundary frequency for the frequency sweep, a step size within the frequency sweep, or any other parameter of the frequency sweep.

The detection of the one or more analytes at 44 can also include transmitting the transmit signal into the target 48. The transmit signal can be transmitted into the target by a transmit antenna of the sensor, such as transmit antenna 11 as described above and shown in FIG. 1. In an embodiment, the transmit antenna used to transmit the transmit signal at 48 can be an antenna included in an antenna array, such as the array shown in FIG. 4, where the antenna is selected based on the biological identity and/or the status obtained at 42.

Detection of the one or more analytes at 44 can further include obtaining a response signal 50. The response signal obtained at 50 results from the transmitting of the transmit signal into the target at 48. The response signal can be obtained using a receive antenna of the sensor such as receive antenna 13 of sensor 5 as described above and shown in FIG. 1. In an embodiment, the receive antenna used to obtain the response signal at 50 can be an antenna included in an antenna array, such as the array shown in FIG. 4, where the antenna is selected based on the biological identity and/or the status obtained at 42.

The response obtained at 50 can be processed at 52 to determine a presence or amount of the one or more analytes, for example through converting the received response signal(s) to values indicative of a presence or amount of the one or more analytes. The processing of the response at 52 can be based on the biological identity and/or status of the subject. For example, the one or more analytes for which the presence or amount are determined can be selected based on the biological identity and/or status of the subject. In an embodiment, the selection of the analytes which the response signal is processed to detect can include detecting particular analytes for a particular subject, detecting particular analytes when the subject is in a particular status, or the like. The processing of the response at 52 can include calibration or other adjustments particular to the biological identity and/or status of the subject, to modify the determination of the presence or amount of the one or more analytes or the results thereof.

Optionally, a notification can be generated based on the presence or amount of the one or more analytes and the biological identity and/or status of the subject 54. In an embodiment, the notification can be a message provided to a subject or other individual for example through a display, such as appearing by way of a push notification, text message, or the like. In an embodiment, the notification can be a command regarding an automated action, with the command being communicated to a device capable of performing the automated action, or the like. For example, the notification generated at 54 can direct operation of an insulin pump. The notification generated at 54 can be based on the biological identity and/or the status of the subject as well as one or more of the analytes detected at 44. For example, the notification can be based on at least one of the one or more analytes detected at 44, with the at least one of the analytes being selected based on the biological identity and/or the status of the subject. In an embodiment, the criteria used for determining whether to generate the notification and/or the content of the notification can be selected based on the biological identity and/or the status of the subject. The selection of the criteria or the analytes to which the criteria are applied to generate the notification at 54 can be based on, for example, the subject's subscriptions to reporting or notification services, the relevance of particular notifications to a subject, the relevance of particular notifications based on the status of the subject, combinations thereof, and the like.

FIG. 3 shows a flowchart of a method for analyte detection according to an embodiment. Method 60 includes determining a biological identity and/or a status of a subject 62. Determining the biological identity and/or the status of the subject includes generating a first transmit signal 64, transmitting the first transmit signal into the subject 66, obtaining a first response to the first transmit signal 68, and processing the response to determine a biological identity and/or a status of the subject 70. Method 60 can optionally include further processing the first response to determine a presence or amount of one or more analytes 72 based on the determined biological identity and/or status. Method 60 can optionally include performing a detection of one or more analytes based on the determined biological identity and/or status of the subject 74. The detection of one or more analytes based on the determined biological identity and/or status at 74 can include generating a second transmit signal 76, transmitting the second transmit signal into the subject 78, obtaining a second response to the second transmit signal 80, and processing the response to determine a presence or amount of the one or more analytes 82.

A biological identity and/or a status of a subject is determined 62. Determining the biological identity and/or the status of the subject includes generating a first transmit signal 64, transmitting the first transmit signal into the subject 66, obtaining a first response to the first transmit signal 68, and processing the response to determine a biological identity and/or a status of the subject 70. The processing of the response to determine the biological identity and/or the status of the subject at 70 can include determining a presence or amount of one or more analytes indicative of biological identity and/or status and determining the biological identity and/or status based on the analytes. The biological identity of the individual can be an identification of the individual including the target as a particular individual, or determining whether the individual including the target is a part of a particular group. The biological identity can be determined, for example, by comparing the presence or amount of at least some of the one or more analytes to known analyte presences or levels associated with particular individuals or groups that the individual may belong to. The one or more analytes used to determine identity can be, for example, DNA sequences, proteins, hormones, bacteria, viruses, portions thereof, particular conformations thereof, combinations thereof, and/or ratios thereof, and the like. The detected presence or amounts of the one or more analytes can be compared to individual or group profiles including specific analytes, ranges and/or ratios for one or more particular analytes, conditional logic regarding combinations, ratios, or the like of the one or more analytes, or any other suitable information for determining whether an individual meets the profile based on the one or more analytes. The status of the individual can be any transient state that can be characterized by the detection of one or more analytes. Non-limiting examples of statuses of the individual that can be determined at 70 can include a sobriety state, an intoxication state, an alert state, a tired state, certain emotional states such as stress or anger, sympathetic or parasympathetic nervous states, glucose states such as high or low blood sugar states, and the like. For example, a sobriety state or an intoxication state can be determined based on the presence or absence of recreational drugs, or amounts of such recreational drugs exceeding predetermined thresholds. Other states can be based on other suitable analytes such as prescription or over-the-counter drugs, metabolites, hormones, bacteria, viruses, glucose, or particular levels, combinations, or ratios thereof. For example, a communicable disease state can be based on a presence or absence of one or more pathogens of interest among the detected one or more analytes. The status of the individual can be determined by comparing at least some of the one or more analytes to criteria for one or more statuses to be determined. The criteria for the statuses can include the presence and/or amount of one or more analytes, conditional logic regarding combinations or ratios of a plurality of analytes, or any other suitable. In an embodiment, the status criteria can be particular to an individual. In an embodiment, both biological identity and status of the subject can both be determined by the processing of the response at 70.

Method 60 can optionally include further processing the first response obtained at 68 to determine a presence or amount of one or more analytes 72 based on the determined biological identity and/or status. In an embodiment, whether the first response obtained at 68 is further processed is determined based on the biological identity and/or status of the subject. For example, further processing to detect one or more analytes at 72 can be conditional on the subject having a proper biological identity and/or status to have access to detection of the one or more analytes. In an embodiment, the one or more analytes for which the presence or amount is determined by the further processing of the first response can be based on the biological identity and/or status of the subject, for example detecting particular analytes for a particular subject, detecting particular analytes when the subject is in a particular status, or the like. The further processing of the first response obtained at 68 can include calibration or other adjustments particular to the biological identity and/or status of the subject, to modify the determination of the presence or amount of the one or more analytes or the results thereof.

Method 60 can optionally include performing a detection of one or more analytes based on the determined biological identity and/or status of the subject 74. In an embodiment, the detection of the one or more analytes at 74 can be permitted or prevented based on the determination of the biological identity and/or status at 62. In an embodiment, the detection of the one or more analytes at 74 can be triggered based on the determination of the biological identity and/or status at 62. In an embodiment, the one or more analytes that are detected at 74 can be selected based on the identity and/or status of the subject. For example, the one or more analytes can be selected based on relevance to a particular subject, relevance based on a status of the subject, subscriptions or permissions regarding analysis of particular analytes, and/or any other suitable criteria for determining analytes to detect based on the identity and/or status of the subject.

The detection of one or more analytes based on the determined biological identity and/or status at 74 can include generating a second transmit signal 76. The transmit signal can be generated at 76 by a transmit circuit of a sensor, such as transmit circuit 15 of sensor 5 as described above and shown in FIG. 1. In an embodiment, characteristics of the transmit signal generated at 76 can be based on the biological identity and/or status of the subject obtained at 62. For example, one or more frequencies included in the transmit signal generated at 76 can be selected based on the biological identity and/or status of the subject, for example to use frequencies known to be particularly effective for detection of the one or more analytes in a particular subject or to use frequencies known to produce responses most indicative of selected analytes being detected. In an embodiment, a range of frequencies for a frequency sweep can be based on the biological identity and/or status of the subject, for example adjusting one or more of a lower boundary frequency for the frequency sweep, an upper boundary frequency for the frequency sweep, a step size within the frequency sweep, or any other parameter of the frequency sweep.

The second transmit signal can be transmitted into the subject at 78. The transmit signal can be transmitted into the target by a transmit antenna of the sensor, such as transmit antenna 11 as described above and shown in FIG. 1. In an embodiment, the transmit antenna used to transmit the transmit signal at 78 can be an antenna included in an antenna array, such as the array shown in FIG. 4, where the antenna is selected based on the biological identity and/or the status obtained at 62.

A second response to the second transmit signal is obtained at 80. The second response signal obtained at 80 results from the transmitting of the second transmit signal into the target at 78. The second response signal can be obtained using a receive antenna of the sensor such as receive antenna 13 of sensor 5 as described above and shown in FIG. 1. In an embodiment, the receive antenna used to obtain the response signal at 80 can be an antenna included in an antenna array, such as the array shown in FIG. 4, where the antenna is selected based on the biological identity and/or the status determined at 62.

The response obtained at 80 is processed to determine a presence or amount of the one or more analytes 82. Processing of the response at 82 can be, for example, converting the received response signal(s) to values indicative of a presence or amount of the one or more analytes. The processing of the response at 82 can be based on the biological identity and/or status of the subject determined at 62. For example, the one or more analytes for which the presence or amount are detected can be selected based on the biological identity and/or status of the subject. In an embodiment, the selection of the analytes which the response signal is processed at 82 to detect can include detecting particular analytes for a particular subject, detecting particular analytes when the subject is in a particular status, or the like. The processing of the response at 82 can include calibration or other adjustments particular to the biological identity and/or status of the subject, to modify the determination of the presence or amount of the one or more analytes or the results thereof.

FIG. 4 shows an antenna array of a sensor according to an embodiment. In the array of FIG. 4 illustrates a plan view of an antenna array having six transmit or receive antennas 11, 13. As shown in FIG. 4, the antennas can be substantially linear strips. In this example, the antennas 11, 13 differ in geometry from one another in that the shapes of the ends of the antennas, the lateral lengths and/or the lateral widths of the antennas differ from one another. As shown in the example of FIG. 3, the antennas 11, 13 are arranged side-by-side with one another. The antennas 11, 13, as shown in FIG. 3 have longitudinal axes that are parallel to one another. The antennas 11, 13 of the array that are used in transmitting a transmit signal and/or obtaining a response during a particular detection operation can be selected based on a biological identity and/or a status of a subject.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An analyte detection system, comprising:
a sensor comprising:
an antenna array having at least one transmit antenna and at least one receive antenna, the at least one transmit antenna is positioned and arranged to transmit a transmit signal into a subject, and the at least one receive antenna is positioned and arranged to detect a response resulting from transmission of the transmit signal by the at least one transmit antenna into the subject;
a transmit circuit that is electrically connectable to the at least one transmit antenna, the transmit circuit is configured to generate a transmit signal to be transmitted by the at least one transmit antenna, the transmit signal is in a radio or microwave frequency range of the electromagnetic spectrum; and
a receive circuit that is electrically connectable to the at least one receive antenna, the receive circuit is configured to receive the response detected by the at least one receive antenna,
a controller configured to:
obtain a biological identity and/or status of the subject, and
control a detection of one or more analytes by the sensor based on the biological identity and/or status of the subject.

2. The analyte detection system of claim 1, wherein the controller is configured to obtain the biological identity and/or status of the subject based on processing of the response detected by the at least one receive antenna.

3. The analyte detection system of claim 1, wherein the controller is configured to obtain the biological identity and/or status of the subject by receiving an authorization permission.

4. The analyte detection system of claim 1, wherein the control of the detection includes initiating, based on the biological identity and/or status of the subject, the detection of the one or more analytes.

5. The analyte detection system of claim 1, wherein the control of the detection includes selection of the one or more analytes.

6. The analyte detection system of claim 1, wherein the control of the detection includes selection of one or more frequencies to be included in the transmit signal.

7. The analyte detection system of claim 1, wherein the control of the detection includes processing of the response based on the biological identity and/or status of the subject.

8. The analyte detection system of claim 1, wherein the controller is configured to obtain the biological identity of the subject and the control of the detection is based on the biological identity of the subject.

9. The analyte detection system of claim 1, wherein the controller is configured to obtain the status of the subject and the control of the detection is based on the status of the subject.

10. A method of detecting one or more analytes, comprising:
obtaining a biological identity and/or a status of a subject; and
controlling a sensor based on the biological identity and/or the status of the subject to non-invasively detect one or more analytes in the subject, wherein non-invasively detecting the one or more analytes includes:
generating a transmit signal using a transmit circuit of the sensor;
transmitting the transmit signal into a subject using a transmit antenna of the sensor, the transmit signal is in a radio or microwave frequency range of the electromagnetic spectrum;
detecting a response resulting from transmitting the transmit signal into the subject using a receive antenna of the sensor; and
processing the response to determine a presence or amount of the one or more analytes in the subject.

11. The method of claim 10, wherein the biological identity and/or the status is obtained by receiving an authorization permission.

12. The method of claim 10, wherein the biological identity and/or the status is obtained by detecting one or more identity or status analytes using the sensor, and determining the biological identity and/or the status based on the one or more identity or status analytes.

13. The method of claim 10, wherein controlling the sensor includes initiating the non-invasive detection of the one or more analytes in the subject based on the biological identity and/or the status of the subject.

14. The method of claim 10, wherein the one or more analytes are selected based on the biological identity and/or the status of the subject.

15. The method of claim 10, wherein one or more frequencies included in the transmit signal are selected based on the biological identity and/or the status of the subject.

16. The method of claim 10, wherein the processing of the response to determine the presence or the amount of the one or more analytes is based on the biological identity and/or status of the subject.

17. The method of claim 10, further comprising providing a notification based on the presence or amount of the one or more analytes and the biological identity and/or the status of the subject.

18. The method of claim 10, wherein the sensor is controlled based on the biological identity of the subject.

19. The method of claim 10, wherein the sensor is controlled based on the status of the subject.
